(19) United States
(12) Patent Application Publication
(10) Pub. No.: US 2004/0238237 A1
(43) Pub. Date: Dec. 2, 2004

(54) Centrifugal force, wind power, electromagnetic energy electric vehicles

(76) Inventor: Yoshioki Tomoyasu, Fujisawa-shi (JP)

Correspondence Address: Yoshioki Tomoyasu, 21-22, Mirokuji 3-chome, Fujisawa-shi, Kanagawa-ken, 251-0016, JP

(21) Appl. No.: 10/447,575

(22) Filed: May 30, 2003

(51) Int. Cl. B60L 8/00

(52) U.S. Cl. 180/2.2

(57) ABSTRACT

The sundry energy sources such as wind power, centrifugal force, electromagnetic energy and etc. which have been wasted are incorporated to the electric vehicles which have been suffered from the small electric density of the battery by the method of introducing new devices enabling to converting resistance to the driving operation of the motor car into accelerating force in driving motor car, thus succeeded in increasing the total driving force to cope with those of the petrochemical fuel engine motor car with by far small manufacturing cost as compared with even those of the petrochemical fuel engine motor car.

### FIELD OF THE INVENTION

The present invention is generally dircted to the electric vehicles for increasing driving power not less than the petrochemical fuel engine thereof. The conventional electric vehicles that have suffered from the small density of the energy as compared with thoseof the petrochemical fuels. Therefore, the driving distance at one time charging thereto is confined to a shart distance despite long charging time required as cpmpared to those of the petrochemical engine fuel motor cars.

### BACKGROUND OF THE INVENTION

On the background that the more strict restriction on exhasting gases caused by the motor cars is liable to be imposed in any market in the world, most of the car manufacturers in the world are apt to devote themselves to develop the hybrid motor cars in view of the fact that it will be taken for much more time to prevail the hydrogen fuel engine motor cars in the market according to the prospect for proceeding the technical development as well as the infratstructure thereof. However, even in the case with the hybrid cars of the petrochemical engine and the electric motor, the manufacturing as well as driving costs thereof remain almost in double as much as those of outstanding costs thereof. This is due to the reason that the hybrid motor cars depend on only the driving force available for the combined use of the conventional petrochamical engine and motor which need respective energy source, thus additional power thereto is not produced.

### SUMMARY OF THE INVENTION

The present invention is directed to incorporate sundory power and energy of sources for the purpose of increasing the driving energy of the electric vehicles such as centrifugal force, wind power and elctromagnetic energy by the method which we have developed for the respective purpopse. The centrifugal force,wind power,electromagnetic energy electric vehicle is equipped with the specific devices such as the ignition coil to produce the high voltage of the electric current to be directly led to the coil of the motor,the driving shaft with the watermill shaped blades therefrom radiating outward thrusted therein with the weight free to slide up and down along the blade thereof causing the centrifugal force which is possible to save the driving energy and the wind power to be converted from resistance to the driving operation to accelerating the rotating operation of the driving shaft taking advantage of wind pressure being subject to the front of the motor car in driving operation to turn the force to accelerate the rotating operation introducing the new shape of the rotating shaft. Furthermore, the new concept substituting the conventional differential gear to make use of the inside space of the motor car more effeiciently and in economical costs. Such new devices we have developed enable to power up the driving force of the electric vehicle in lowest production costs by use of wasted energy.

### BRIEF DESCRIPTION OF THE DRAWINGS

FIG. 1 is the circuit of the electric wire raising voltage with the electromagnetic energy through the ignition coil finally leading to the coil of the stationary of the motor.

FIG. 2 is the side view of the centrifugal force system applied to the driving shaft of the electric vehicle.

FIG. 3 is the side view of the anti-skid system taking advantage of the centrifugal force system.

FIG. 4 is the cross sectional view of the handle differential system adopted to the driving shaft and the wheel of the tire thereof.

### DETAILED DESCRIPTION OF THE INVENTION

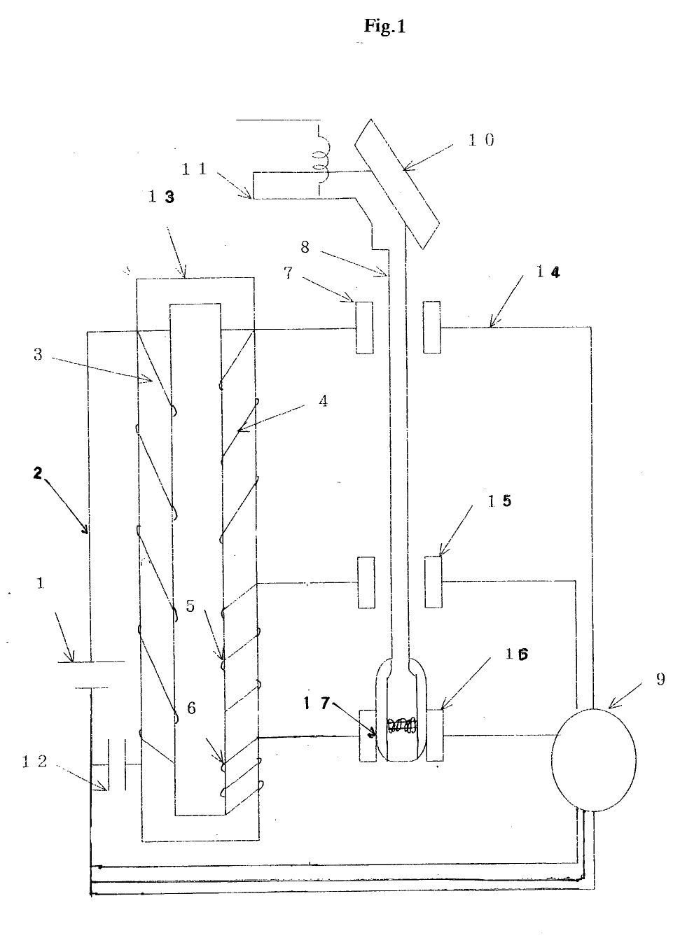

As shown FIG. 1, the battery 1 is combined with the lead cable of the ignition coil 2 designed to produce the intermittent electric current in 1st coil 3 by means of either contact point or pulse motor system to induce high voltage in 2nd coil 4,5, and 6 respectively winding metal bar 13 by dint of the electromagnetic induction. The voltage induced in the 2nd coil 4,5 and 6 depend upon the number of winding the metal bar 13 at a constant unit to be raised in proportion to that of the 1st coil 3 of which electric current is capable of being made arrangement by the condenser 12. In view of the case of the gasoline engine motor car of which voltage of the battery on board is raised from 12V to 10,000V in the 2nd coil of the ignition coil thereof to spark through the distributor,it is apparent the high voltage is available for the electric current therein. As illustrated in FIG. 1, the plural windings at 2nd coil 4,5, and 6 independently constitute the winding extending cable, for example, to the terminal 7 at each stage where the space interval exist between the corresponding terminal in opposite side 15 and 16. The opposite side cable 14 is led directly to the coil of the stationary of the motor 9. In the event that the wider portion 17 of the metal pole 8 geared with the accel pedal 10 and the governor 11 is made contact with both sides interval 16 as illustrated in FIG. 1, the lead wire 14 is allowed to transmit the high voltage of the electlic current directly to the coil of the stationary of the motor 9 with strong torque. Thus,the design enables to eliminate the necessity for the speed arranging gear and the transmission of the motor car. Furthermore, presuming that one of windings in the 2nd coil as well as one of the coil of the stationary of the motor is set in the adverse direction, the motor revolute in the adverse direction, thus the electric motor car is possible to move back and forth only by the action of stepping the accel pedal in driving operation.

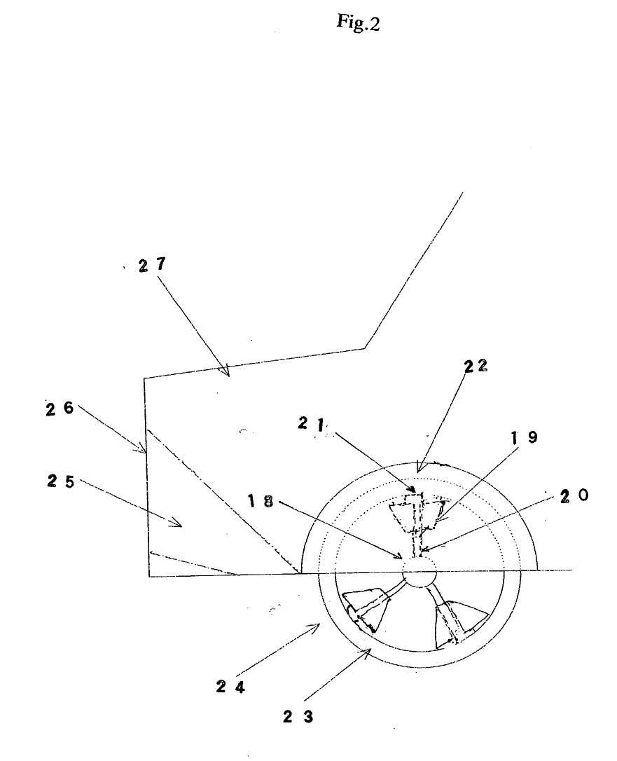

As shown in FIG. 2, the driving shaft 18 equipped with the watermill shaped blades 20 thereon radiateing straight outwardly with weights thrusted through therein being free to slide up and down along the shaft and transmitted to the end thereof by the metal stopper 21 in rotating operation.

The centrifugal force F is produced as the following formula; F=MRW² (M=weight, R=Length of the blade, W=Angle speed in rotating), thus the rotating force is saved by F(Centrifugal force), therefore, presuming that the length of R is set at fivefold as compared with that of a crankarm and M=weight being threefold as that of the shaft, 5×3=15(fold)to be saved in driving energy as compared with that of the petrochemical fuel engine motor car. On the other hand,the wind power at the front of the motor car 25 is designed to be attracted through the wind passage 26 to accelerate the blade 20 of the shaft 18 in rotating by use of Ventury to prevent the wind from being against the wind in the direction. Taking an example of the driving speed at 100 km/h,(=100,000 km/h, thus 100,000÷60÷60=27.8 m/sec. almost equiverent to the wind power of the average typhoon which is turned to the accelerator for driving operation,it enables to reduce the driving energy in considerable degree. The metal cover 22 with the half upper tire 24 is designed to prevent the against wind from becoming resistance to the shaft revolution,thus the blade 20 is possible to rotate in high efficiency.

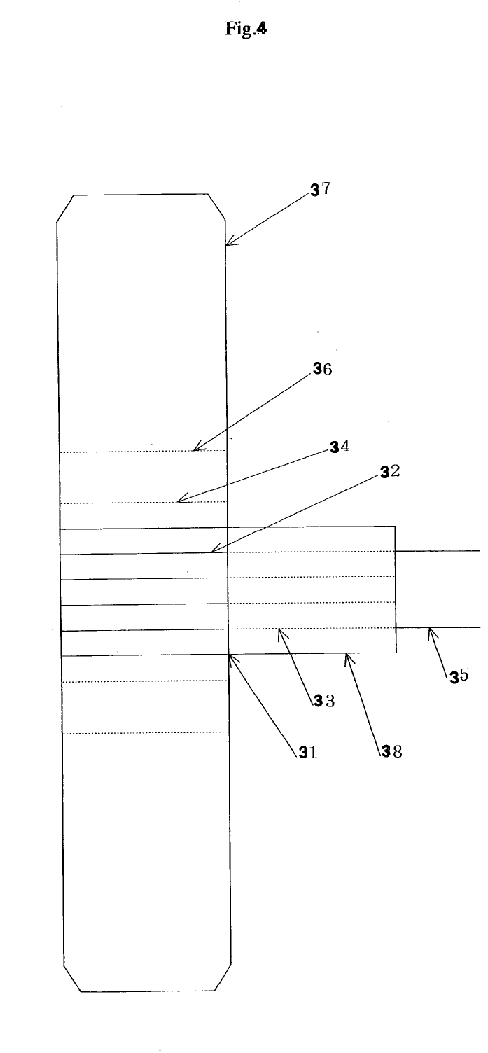

As shown in FIG. 3, when the senser 29 setting in the tire 24 informs of the possibility of slip taking place between the tire 24 and the ground 30, the stopper 21 in the engagement to keep the weight 19 at the end of the blade 20 as illustrated in FIG. 3 is automatically detached, thus the weight 19 is apt to be released to slide out with whole length along the blade of the rotating shaft 18 to be hooked with the roof plate 29 of the weight 19, thus the length of the radium of the rotating blade 20 become prolonged to contact the ground with the bottom of the weight 19 in rotating operation most likely to produce the large friction force between the weight 19 and the ground 30 preventing from possible skid therebetween.

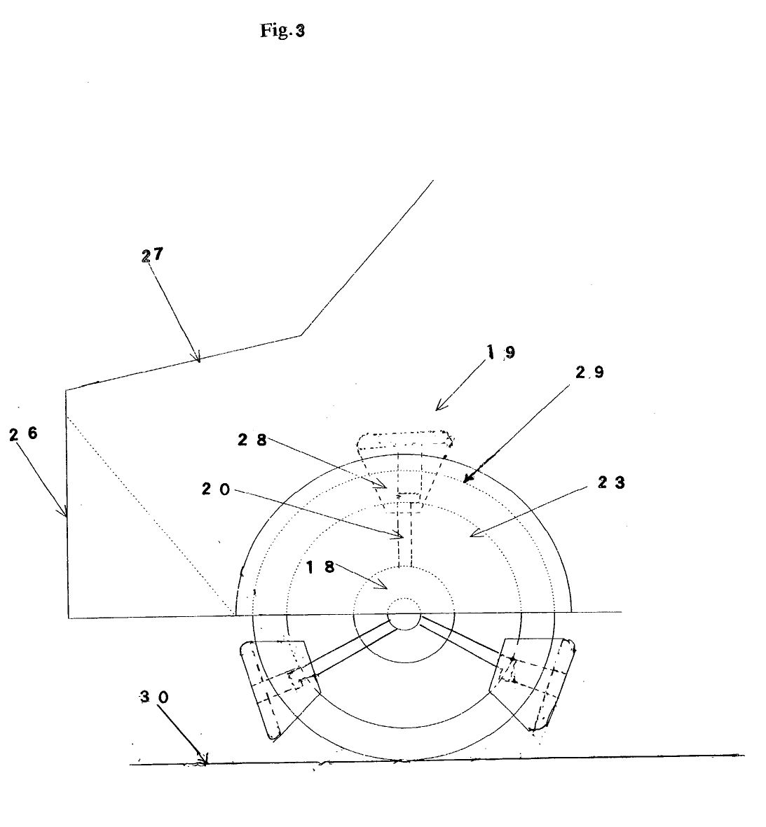

As shown in FIG. 4, the inside spline 33 of the metal collar 31 being in the engagement with the driving shaft 35 is designed to transfer the rotating torque to the tire 37 through the wheel 36 in the engagement With the spline 34 processed on the surface of the metal collar 31 is possible to be moved outward horizontally along the driving shaft by dint of the hydraulic pressure geared with the power steering which operate on exceeding a certain turning angle in the handle operation in driving motor car. The surface of the metal collar 31 is divided into two portion, outward surface being processed in spline 34 and inner surface being smooth surface 38. Within the compass of the turning angle in handling operation, the outward spline 34 of the metal collar 31 is in the engagement with the wheel 36, thus

1. Ignition coil is employed to the electric circuit to produce the high voltage of the electric current to the electiric vehicles.
a. The plural windings in the 2nd coil extending respective cable with terminals intercepted with space interval constituting the function of the controller.
b. The space interval is filled with the wider portion of the metal pole to combine the lead cable enabling to transmit the electric current directly to the coil of the motor.
c. The winding in the 2nd coil as well as the coil of the motor wound in adverse direction enables to rotate the motor in adverse direction thus possible to drive the motor car to back and forth.

2. Centrigugal force is taken advantage of saving driving energy by use of the watermill shaped blade to the rotating shaft.
a. The weight is thrusted into the blade fixed on the rotating shaft in radiating outward being free to slide up and down along the blade.
b. The blade and weight produce the centrifugal forces in driving either to save the driving energy or increase the driving force.
c. In case of slip between the tire and the ground, the weight is made contact with the ground producing large friction which prevent from possible slip between the tire and the ground.

3. The metal collar coupled with the driving shaft and the wheel enables to make the motor car curve instead the conventional differential gear with simple and economical method by use of both spline process as well as the power steering.
a. The metal collar divided into two portions, i.e.,the outside surface being porocessed in spline and the inner surface being flat, both inside wall of the collar is processed in spline.
b. The difference between the rotating speed of the inside tire and the outside tire produced by the conductivity of the torque to the wheel due to the engagement of spline of flat surface of the collar.
c. The power steering is applied to the pushiing force to the collar beyond a certain turning angle.
